(19) United States
(12) Patent Application Publication
(10) Pub. No.: US 2003/0187711 A1
(43) Pub. Date: Oct. 2, 2003

(54) Processing system for judging unoccupied time from schedule information of user, server and program

(75) Inventor: Hiroyuki Komai, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/307,999

(22) Filed: Dec. 3, 2002

(30) Foreign Application Priority Data
Mar. 28, 2002 (JP) 2002-091800

(51) Int. Cl. G06F 17/60

(52) U.S. Cl. 705/8

(57) ABSTRACT

A technology of the present invention enables a predetermined process other than essential processes supporting the work of a user in a processing system to be executed in an unoccupied time of the processing system. The processing system executing the predetermined process includes a module referring to schedule information of a user using the processing system, a module judging, based on the schedule information, an unoccupied time of the processing system for which the user does not use the processing system, and an execution module executing a predetermined process in the unoccupied time.

### BACKGROUND OF THE INVENTION

The present invention relates to a variety of processing systems dealing with information processing etc.

Processing systems such as personal computers etc spread over working places and individual homes, wherein each processing system supports the works and a daily life of the user. Nowadays, these processing systems come to gain remarkably-enhanced performances. A data size to be processed, however, increases, and hence the processing capacity thereof does not necessarily have an allowance. Further, in these processing systems, in addition to the essential processes supporting the works of the user, there are executed a variety of processes for maintaining the processing systems in their adequate states.

For instance, the Internet becomes a day-to-day use global web, and various categories of information are exchanged over the Internet. While on the other hand, damages caused by computer viruses occur one after another. A countermeasure is a virus check/purging tool that is now utilized, and the users are required to perform operations such as a periodical check and updating a pattern file.

For attaining this, the users prevent themselves from failing to check by utilizing a time-specified automatic check function. It might, however, happen that the personal computer is not yet started up at the specified time and then the virus check cannot be started.

Further, the virus check needs a high processing load, which might decrease a processing speed of a processing system executing other processes simultaneously. Therefore, a startup time of the virus check is, in the great majority of cases, specified in a lunch break for which the user does not use the processing system. However, a volume of hard disk is increased in recent years and it leads to long processing time of the virus check processing. Then, an elaborate check of the viruses infecting the files in multiple forms does not often finish within the lunch break. The result is that the essential operations of the user might be hindered.

Further, in addition to the virus check, for example, various categories of processes such as a process of obviating a fragmentation causing a delay of an access time to a hard disk (a program for executing this process is called a defragmentor), a process of clearing a real content of the computer file deleted, a data backup process etc, are executed in the processing system.

A smooth execution of the essential processes supporting the works of the user requires executing and finishing the non-essential processes described above within an unoccupied time for which the processing system is unused without the user's being aware of it.

### SUMMARY OF THE INVENTION

It is a primary object of the present invention, which is devised to in view of the problems inherent in the prior arts described above, to provide a technology capable of making a processing system execute a process other than essential processes supporting works of a user in the processing system within an unoccupied time of this processing system.

To accomplish the above object, according to one aspect of the present invention, a processing system executing a predetermined process includes a module referring to schedule information of a user using the processing system, a module judging, based on the schedule information, an unoccupied time of the processing system for which the user does not use the processing system, and an execution module executing a predetermined process in the unoccupied time.

This processing system refers to the schedule information of the user, judges the unoccupied time of the processing system for which the user does not use the processing system, and executes the predetermined process in this unoccupied time.

Accordingly, the predetermined process can be restrained from being executed during a period for which the user uses the processing system. This type of processing system is effective especially in a case where the predetermined process has a high load.

Preferably, this processing system may further include a module referring to a processing time needed to complete the predetermined process when the predetermined process was executed in the past, and a module comparing the processing time with the unoccupied time, wherein the execution module may execute the predetermined process if the processing time does not exceed the unoccupied time.

According to this processing system, the processing time when executing the predetermined process in the past is compared with the unoccupied time described above, and the unoccupied time can be set so that the execution of the predetermined process is completed within this unoccupied time.

Preferably, the predetermined process is a data process, and the processing system may further include a module recording information on a used storage capacity of data processed by this data process and a processing time of the data process of the same data, a module estimating the processing time from a relationship between the information on the used storage capacity when the data process was executed in the past and information on a present used storage capacity, and a module comparing the estimated processing time with the unoccupied time, wherein the execution module may execute the predetermined process if the estimated processing time does not exceed the unoccupied time.

According to this processing system, the processing time is estimated from the relationship between the information on the used storage capacity when the data processing was executed in the past and the information on the present used storage capacity, and can be therefore estimated more accurately.

Preferably, this processing system may further include a module referring to an unused storage capacity of a medium storing the data, wherein the estimating module may estimate the processing time in a way that uses the unused storage capacity as the information on the used storage capacity.

In the processing system in which the unused storage capacity is easier to obtain, the unused storage capacity is acquired, and the present used storage capacity may be obtained from the whole storage capacity and unused storage capacity.

Preferably, the module referring to the schedule information may refer to schedule information retained on a predetermined server.

Preferably, the processing system may further include a module detecting a user operation, and a module controlling the execution of the predetermined process on the basis of a result of detecting the user operation. The control of the execution of the process means, for example, stopping the execution of the predetermined process just when detecting, e.g., a user's operation.

This also implies having the predetermined process executed if, for example, the user's operation is not detected. According to this processing system, the execution of the predetermined process is controlled based on a result of detecting the user's operation, and hence the predetermined process can be executed in a way that reflects an actual system using state of the user.

Preferably, the predetermined process may include any one of processes or one or more processes such as a computer virus check process, an integrating process of free areas on the medium storing the data, a delete process clearing a real content of already-deleted data and a copying process of the predetermined data.

According to another aspect of the present invention, a server communicating with a processing system includes a module referring to schedule information of a user using the processing system, a module judging, based on the schedule information, an unoccupied time of the processing system for which the user does not use the processing system, and a module commanding the processing system to execute a predetermined process in the unoccupied time.

Namely, according to the present invention, for instance, the server accessible to the schedule information of the user judges the unoccupied time of the processing system on the basis of the schedule information thereof, and commands the processing system to execute the predetermined process.

According to still another aspect of the present invention, a server accessing resources possessed by a predetermined processing system, includes a module referring to schedule information of a user using the processing system, a module judging, based on the schedule information, an unoccupied time of the processing system for which the user does not use the processing system, and a module executing a predetermined process about the resources of the processing system in the unoccupied time.

According to the present invention, the server judges the unoccupied time of the processing system from the schedule information of the user, then accesses the resources of the processing system and executes the predetermined process in this unoccupied time. Herein, the resources of the processing system are, e.g., a hard disk, a memory, a CPU etc of the processing system.

Preferably, the server may further include a module judging whether the processing system is in a halt state, and a module starting up the processing system when the processing system is in the halt state.

According to the present invention, when the processing system remains halted, the server starts up the processing system to execute the predetermined process. Accordingly, even if the user of the processing system is absent for many hours or a long period of time and the processing system therefore remains stopped, the predetermined process can be executed.

Preferably, the server may further include a module referring to a processing time needed t complete the predetermined process when the predetermined process was executed in the past, and a module comparing the processing time with the unoccupied time.

Preferably, the predetermined process is a data process, and the server may further include a module recording information on a used storage capacity of data processed by this data process and a processing time of the data process of the same data, a module estimating the processing time from a relationship between the information on the used storage capacity when the data process was executed in the past and information on a present used storage capacity, and a module comparing the estimated processing time with the unoccupied time.

Preferably, the server may further include a module referring to an unused storage capacity of a medium storing the data, wherein the estimating module may estimate the processing time in a way that uses the unused storage capacity as the information on the used storage capacity.

Preferably, a server may further include a module detecting a user operation about the processing system, and a module controlling the execution of the predetermined process on the basis of a result of detecting the user operation.

Any one of the components of the present invention maybe actualized as a program of the computer.

According to a further aspect of the present invention, there is provided a method by which any one of the processes described above is executed by the computer or other device or machine.

According to a still further aspect of the present invention, there is provided a program designed for the computer or other device or machine to actualize any one of the functions, the processing steps or the processes described above.

According to a yet further aspect of the present invention, there is provided a recording medium recorded with the above program readable by the computer or other device or machine.

As explained above, according to the present invention, the predetermined process other than the essential processes supporting the works of the user in the processing process can be executed in the unoccupied time of the processing system. The present invention is effective especially in the process requiring the long processing time.

### BRIEF DESCRIPTION OF THE DRAWINGS

FIG. 1 is a view showing a system architecture of an information system in a first embodiment;

FIG. 2 is a diagram showing a screen example of a schedule management site 10;

FIG. 3 is a diagram showing a data example of a schedule table database 5;

FIG. 4 is a diagram showing a data example of a machine information database 6;

FIG. 5 is a flowchart showing a process of a program executed by an information system in a first embodiment;

FIG. 6 is a diagram showing a data example of a processing result database 7;

FIG. 7 is a diagram showing an example of a process of estimating a processing time based on a hard disk used capacity in a modified example 1 of the first embodiment;

FIG. 8 is a view showing a system architecture of the information system in a modified example 2 of the first embodiment;

FIG. 9 is a view showing a system architecture of the information system in a modified example 3 of the first embodiment;

FIG, 10 is a flowchart showing a process of detecting an idle state of a personal computer 2;

FIG. 11 is a flowchart showing a process of the program in a second embodiment; and

FIG. 12 is a flowchart showing a process of the program in a third embodiment.

### DETAILED DESCRIPTION OF THE PREFERRED EMBODIMENTS

Preferred embodiments of the present invention will hereinafter be described with reference to the accompanying drawings.

<<First Embodiment>>

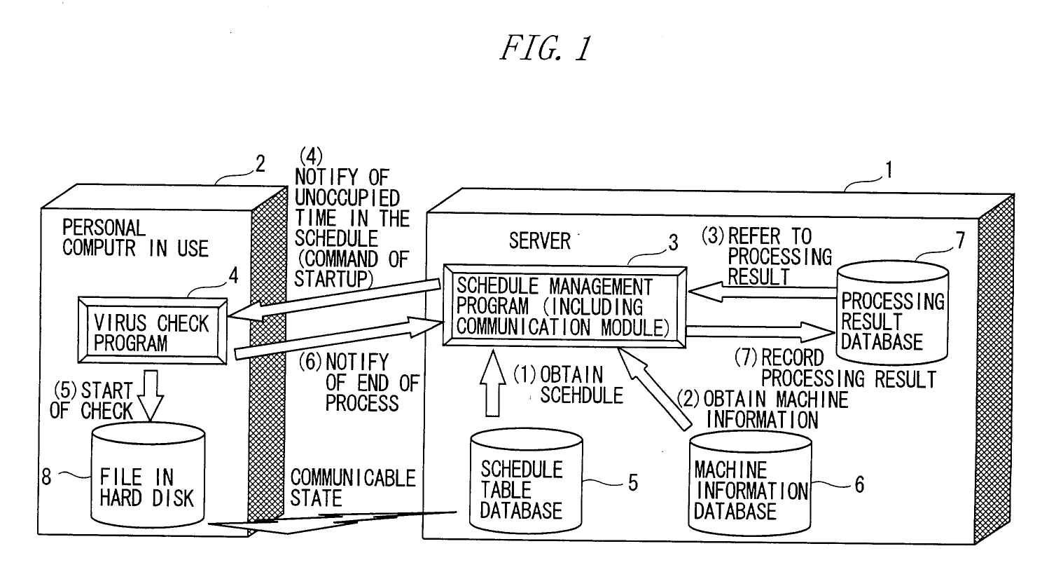

A first embodiment of the present invention will be discussed referring to FIGS. 1 through 9.

<Outline of Function of Information System>

The discussion in the first embodiment will be focused on a function of preventing a process (which will hereinafter be called a predetermined process) that has a large load and does not support a substantial work of a user from hindering operations of the user in an information system.

FIG. 1 is a view showing an system architecture of the present information system. This information system includes a server 1 for providing services to personal computers 2 used by the users. Note that hardware architectures of the personal computer 2 and the server 1 and a software architecture of a system program such as OS (Operating System) etc, are broadly known, and therefore their explanations are omitted.

According to the first embodiment, the discussion will be made in a way that exemplifies a virus check as a predetermined process about a hard disk 8 of the personal computer 2. To be more specific, according to the first embodiment, the personal computer 2 executes a virus check program 4, thereby doing a virus check about a file 8 within the hard disk.

The embodiment of the present invention is not, however, limited to the scheme described above. Further, the embodiment of the present invention does not limit the predetermined process to the virus check. The predetermined process may include, for instance, a process of obviating a fragmentation in which free areas on the hard disk are distributed with the result that an access time to the hard disk is delayed (wherein a program for executing this process is termed a defragmentor), a process of clearing a substance of a computer file deleted, a process of backing up the data and so on. These processes are not essentially required by the operations of the user but are needed for the reasons of keeping the personal computer 2 in good conditions and enhancing a security and so forth. Further, executions of these processes lead to an increase in loads on a CPU and peripheral devices in the majority of cases.

As shown in FIG. 1, the server 1 has a schedule management program 3 defined as one function of groupware. Moreover, the schedule management program 3 retains pieces of schedule management information for the respective users of the personal computers 2 on a schedule table database 5. Further, the schedule management program 3 has a communication module for starting up the virus check on the personal computer 2.

Moreover, the server 1 includes a machine information database 6 for recording information on hardware resources etc of the personal computers 2 used by the individual users, and a processing result database 7 for recording results of processing time when executing the virus check on each of the personal computers 2.

A machine unused time same length as a virus check time or longer than it is needed so that the execution of the virus check does not hinder the user's operations on the personal computer 2.

Therefore, the present information system utilizes the information (the schedule management information stored on the schedule table database 5) of the schedule management program 3 of the server 1. Namely, the present information system refers to the schedule management information of the user and judges whether there is an unoccupied time for which the user does not use the personal computer 2. Then, the present information system executes the virus check for this unoccupied time.

To start with, the server 1 refers to the schedule table database 5 managed by the schedule management program 3 (as indicated by (1) in FIG. 1). Then, the server 1, if it comes to a time when a schedule of the user is set on the schedule table database 5, checks whether a place set in this schedule excludes a user's seat. The [place set in the schedule] is normally a place where the user carries out this schedule. Such a place may be, e.g., the user's seat, a meeting room, a name of other division in the office, a name of organization outside the office, a user's home and so on.

If the place is other than the user's seat or other than being unmentioned (blank), the server 1 judges that it is a unoccupied time for which the user does not use the personal computer 2 in this time zone. Then, the server 1 refers to the information in the machine information database 6 or the information in the processing result database 7, thereby estimating a processing time expended for the virus check (as indicated by (2), (3) in FIG. 1).

Herein, the machine information is defined as information on the resources of the personal computer 2 such as a performance of the unillustrated CPU, a memory capacity, a hard disk capacity, a present free disk capacity and so on. Further, the processing time may be calculated by such a calculation formula that a typical value of the processing time of the specified CPU is reversely proportioned by a CPU clock count.

Further, the server 1 records the result value of the processing time on the processing result database 7 beforehand, then refers to the processing time in the past and may use it as an estimated value of the next processing time ((3) in FIG. 1). The processing time can be estimated more accurately by use of the result value in the past.

Then, the server 1 compares the unoccupied time referred to with the estimated processing time. Then, if the unoccupied time is longer than the estimated processing time, the server 1 commands the personal computer 2 to start up the virus check through the communication module (as indicated by (4) in FIG. 1).

The personal computer 2 receives the command from the server 1 and starts up the virus check (as indicated by (5) in FIG. 1).

At this time, the unillustrated communication module of the server 1 waits till the virus check is finished. The personal computer 2 notifies the server 1 of an end of the virus check, or the server 1 monitors the end of the virus check (as indicated by (6) in FIG. 1), whereby the server 1 obtains a processing time spent till the virus check is ended since the time of issuing the startup command. Then, the server 1 records this processing time on the processing result database 7 (as indicated by (7) in FIG. 1).

Note that if the [place set in the schedule] is the user's seat or remains in blank, the server 1 does not issue the command of starting up the virus check described above.

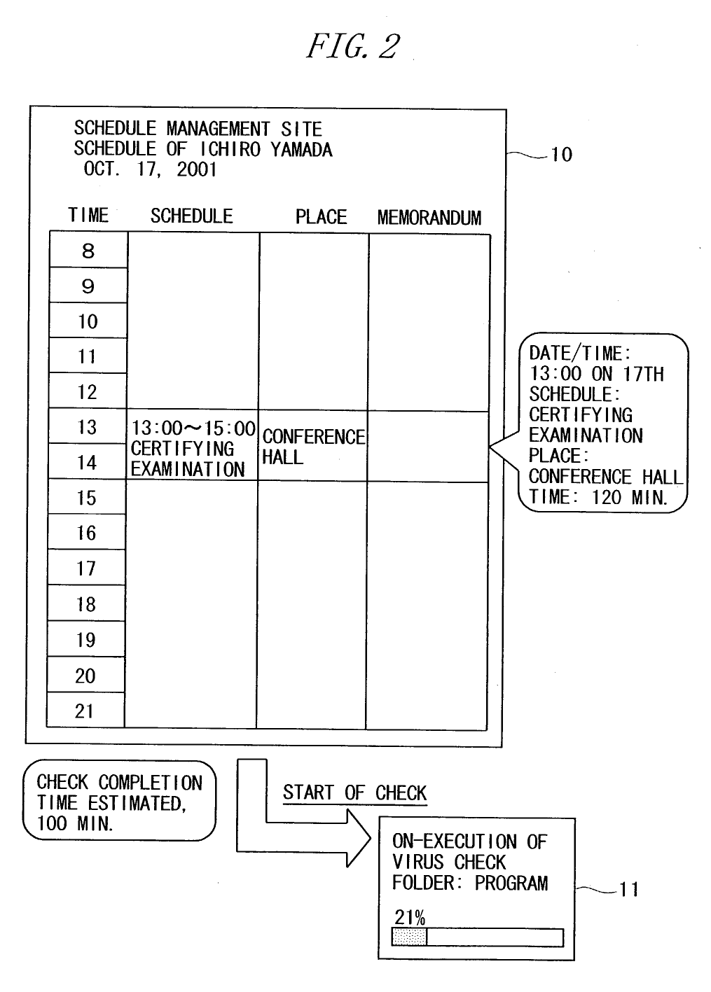

FIG. 2 shows a display example of a schedule management site 10 provided to the personal computer 2 by the schedule management program 3 shown in FIG. 1. A content on the screen of this schedule management site 10 is described in HTML (HyperText Markup Language) and may be displayed by Browser executed on the personal computer 2 in linkage with a Web server program executed on the server 1.

As shown in FIG. 2, a one-day schedule (October 17) of a certain user (Ichiro Yamada) is displayed on this screen. On this screen, time (e.g., from 8:00 to 21:00) of one day is displayed along the vertical axis, and columns of [schedule], [place] and [memorandum] are displayed along the horizontal axis.

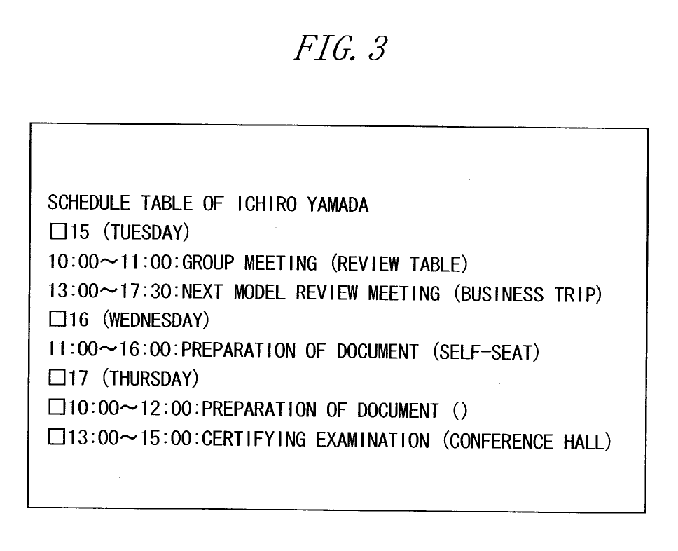

A time zone and an outline of the schedule are displayed in the [schedule] column. Further, the place where the user carried out the schedule in the time zone set in the [schedule] column, is displayed in the [place] column. For example, according to the schedule in FIG. 3, this user is scheduled to receive a certifying examination at a conference hall for 120 minutes from 13:00 to 15:00.

In this case, immediately before this schedule, the server 1 refers to an unoccupied time of 120 minutes. Further, the server 1 refers to the machine information database 6 or the processing result database 7, thereby obtaining the actual value of the virus check processing time (a check completion time) in the past.

Then, if the processing time is, e.g., 100 minutes, the virus check can be completed within a range of the unoccupied time, and hence the server 1 commands the personal computer 2 to start up the virus check. In response to this command, the personal computer 2 starts up the virus check, and displays a window 11 showing a state of this execution on the screen.

<Data Structure>

FIG. 3 shows an example of data (schedule management information) in the schedule table database 5. The data in the schedule table database 5 are segmented on a dating basis for each user. FIG. 3 shows the data of Ichiro Yamada. FIG. 3 also shows, though a year and a month are omitted, day data such as 15th (Tuesday), 16th (Wednesday), 17th (Thursday) and so on.

Further, a data record dated respectively retains pieces of schedule management information delimited by a time zone. Each item of schedule management information (which may also called a schedule) contains a time zone, an outline of the schedule, and a place where the user carries out the schedule for this period of time. FIG. 3 shows an example where this [place] is recorded in a character string put in parentheses “( )”.

Another scheme may be used, wherein the schedule table database 5 consists of table-formatted data (a set of data having a fixed length), and the [place] may be recorded in a predetermined field of the fixed length data. Still another scheme may also be used, wherein the schedule table database 5 is described in XML (eXtensible Markup Language), and a region for recording the [place] is defined by an XML tag set.

For instance, it can be known in the example shown in FIG. 3 that the user (Ichiro Yamada) of this schedule is scheduled to attend a group meeting held at a review table from 10:00 up to 11:00 on 15th (Tuesday). It is also known that the same user is scheduled to prepare a document at his seat from 11:00 up to 16:00 on 16th (Wednesday).

It is further known that this user is scheduled to prepare a document at the user's seat from 10:00 to 12:00 on 17th (Thursday). In this case, the parentheses “( )” are blank, and hence the [place] is set to the user's seat. Moreover, it is known that the same user is scheduled to receive the certifying examination held at the conference hall for a period from 13:00 to 15:00 on 17th (Thursday).

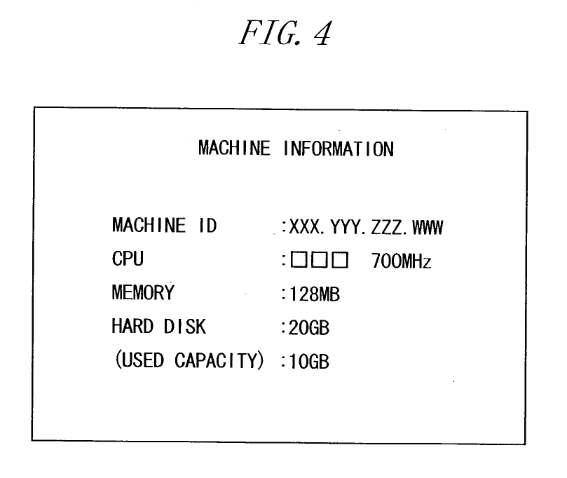

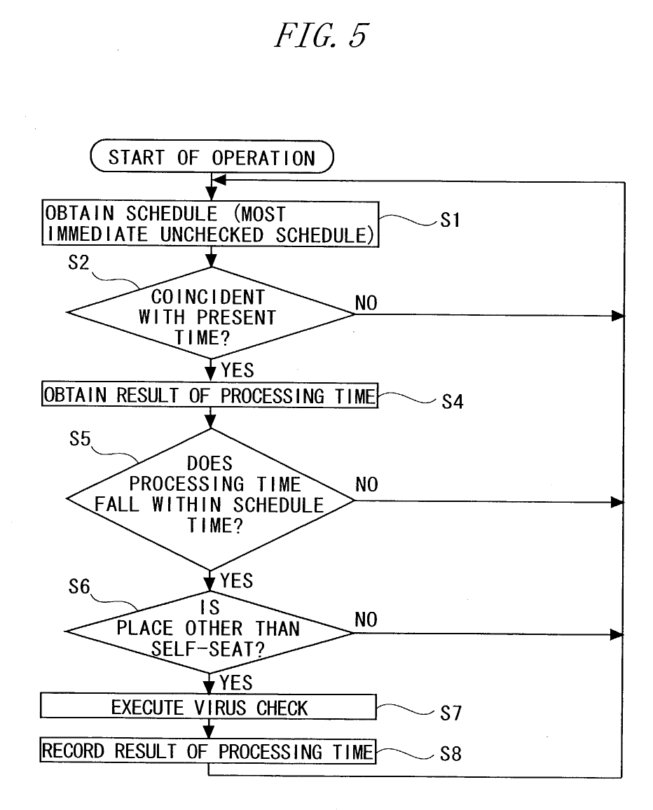

FIG. 4 shows an example of data in the machine information database 6. Each record of the data in the machine information database 6 is identified by a machine ID, and retains pieces of hardware information of the personal computer 2 utilized by each user.

Herein, the machine ID is a piece of information for uniquely identifying the personal computer 2 defined as a processing target on the network. The machine ID is, for example, an IP address of the personal computer 2, a MAC (Media Access Control) address of an Ethernet board mounted in the personal computer 2, a computer name unique to the computer, and so on.

Moreover, pieces of the hardware information are, for instance, a type of the CPU, a clock count, amemory capacity, a hard disk capacity, a used capacity of the hard disk, a free capacity of the hard disk and so forth.

FIG. 4 shows one record of the data in the machine information database 6. The machine information on the single personal computer 2 is managed based on this one record.

<Operation>

FIG. 5 shows a process of the program for starting up the predetermined process in the present information system (the server land the personal computer 2). This process is given to one single user.

This process starts with obtaining an unchecked schedule (schedule management information) closest to the present time from the schedule table database 5 by the server 1 (S1). Then, the server 1 judges whether a start time of this schedule is coincident with the present time (S2). The coincidence herein implies that a difference between the schedule start time and the present time falls within a predetermined value. If the schedule start time is not coincident with the present time, the server 1 returns the control S1.

Whereas if the schedule start time is coincident with the present time, the server 1 obtains a result of the processing time from the processing result database 7 (S4). Note that if the process shown in FIG. 5 is executed at first, a general initial value is set as a result value of the processing time. This initial value is a value estimated from the CPU performance of the personal computer 2 and the hard disk capacity.

Next, the server 1 uses the result value of this processing time as an estimated value of the processing time. Then, the server 1 judges whether the estimated value of the processing time falls within the schedule time (S5).

Then, if the processing time does not fall within the predetermined time, the server 1 returns the control to S1. Further, whereas if the processing time falls within the predetermined time, the server 1 judges whether the user exists somewhere other than at the user's seat (S6).

If the user is at the user's seat (NO in S6), the server 1 returns the control to S1. Whereas if not at the user's seat (YES in S6), the server 1 issues a command via the communication module to the personal computer 2 to execute the virus check (S7) At this time, the communication module waits till the execution of the virus check is completed.

Then, after the execution of the virus check has been finished, the server 1 counts a processing time of the virus check. Then, the server 1 records a result value of this processing time on the processing result database 5. Thereafter, the server 1 returns the control to S1.

<Effects of the Embodiment>

The present information system refers to the processing time of the predetermined process such as virus check etc in the past. Then, the present information system compares the actual value of the processing time with the unoccupied time in the schedule and, if the processing time falls within the unoccupied time, starts up the predetermined process. As a result, it is possible to increase a probability that the predetermined process is completed within the unoccupied time.

Accordingly, for instance, there decreases a case where the virus check is not yet completed even though the user desires to use the personal computer. Further, there is no necessity of performing such a setting that the virus check be periodically carried out, and the personal computer 2 can be safeguarded from computer viruses without the user's being aware of it.

Moreover, in addition to the setting that the predetermined process be periodically carried out, the predetermined process can be executed within the unoccupied time. This scheme makes it possible to reduce a probability that the must-execute processes such as backing up the data on the hard disk and so on without being limited to the virus check described above, fail to be executed.

<Example of Estimating Processing Time Based on Used Storage Capacity of Processing Target Device>

According to the information system in the first embodiment described above, the result value of the processing time of the predetermined process (e.g., the virus check) executed in the past, is used as the estimated value. Then, the information system compares the estimated value of the processing time with the unoccupied time in the schedule table database 5, thereby judging whether the process will be finished within this unoccupied time. This estimated value may be made more precise by modifying the same estimated value on the basis of a used storage capacity of a processing target device.

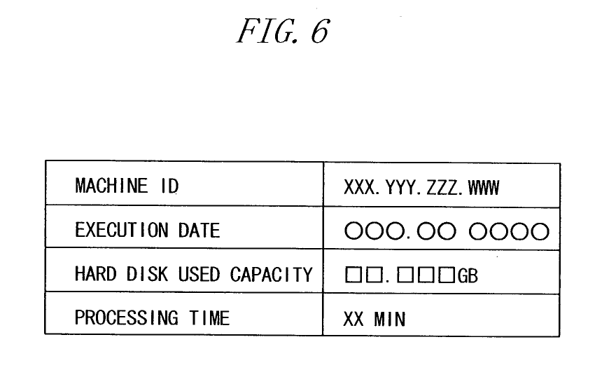

FIG. 6 shows an example of data on the processing result database 7 for making such an estimation. In this case, as shown in FIG. 6, the data in the processing result database 7 may be structured to include a machine ID, an execution date, a hard disk used capacity, and a processing time. The machine ID is the same as the machine ID in the machine information database 6 explained above.

The execution date is a date on which the predetermined process such as the virus check etc is executed. The hard disk used capacity is a used capacity of the hard disk of the personal computer 2. As a substitute for the used capacity, however, a free capacity may also be recorded. This is because a used storage capacity (just when executing the virus check) of the processing target device can be calculated from this free capacity and the hard disk capacity in the machine information database 6. The processing time is a processing time expended for the predetermined process (virus check) at that time.

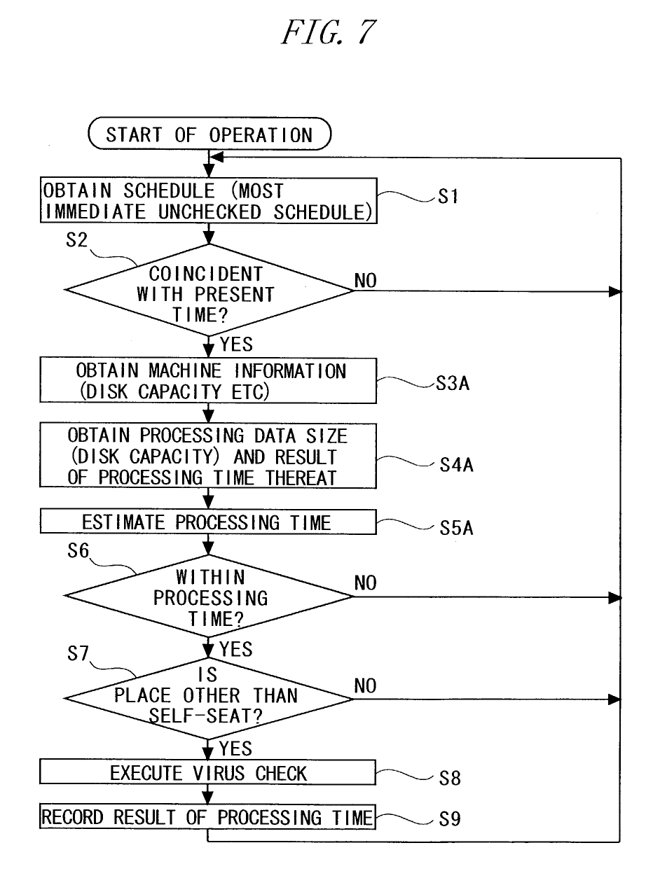

FIG. 7 shows an example of the process of estimating the processing time on the basis of the hard disk used capacity. This estimation process is substantially the same as the process shown in FIG. 5 except for steps S3A through S5A. Such being the case, the explanations of the same steps are omitted.

Namely, the server, if the schedule in the schedule table database 5 is coincident with the present time (YES in S2), obtains the present disk used capacity etc from the machine information database 5 (S3A).

Next, the server 1 acquires the used storage capacity (a hard disk used capacity at that time) in the past process and the actual value of the processing time from the processing result database 7.

Then, the server 1 estimates a processing time of the virus check from the present disk used capacity and from the disk used capacity in the past process and the actual value of the processing time (S5A). The estimation of the virus check processing time in this process can be attained by recording a plurality of points a relationship between the hard disk used capacity in the past and the actual value of the virus check processing time at that time and by interpolating or extrapolating a value of the present hard disk used capacity. Further, the relationship between the hard disk used capacity in the past and the actual value of the virus check processing time at that time, may be described in an empirical formula, and the processing time may be estimated from the present hard disk used capacity. Thereafter, the process is the same as in the case of FIG. 5.

As discussed above, the processing time can be more accurately estimated by referring to the hard disk used capacity (or free capacity) than by the process described in the first embodiment. As a result, the virus check can be completed more surely within the time unoccupied by the user.

<Modified Example in System Architecture>

According to the embodiment discussed above, the server 1 obtains the unoccupied time for which the user does not use the personal computer 2 on the basis of the schedule table database 5 of the user, the machine information database 6 or the processing result database 7. Then, the server 1 commands the personal computer 2 to execute the virus check within that unoccupied time. The embodiment of the present invention is not, however, limited to this scheme.

For example, the present invention can be embodiment also in an information system that does not use the server 1. Namely, the personal computer 2 retains the schedule management program 3, the schedule table database 5, the machine information database 6 and the processing result database 7, wherein the process described above may be executed within the personal computer 2.

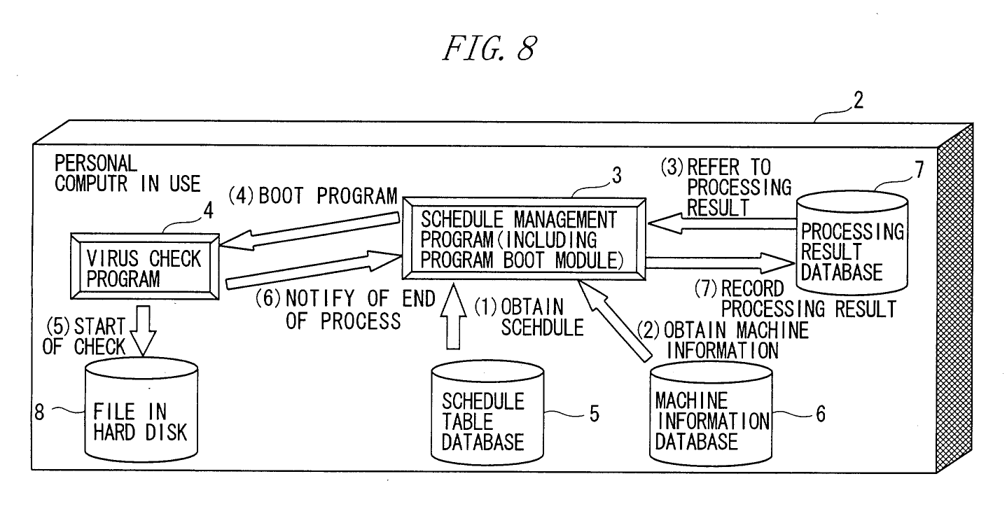

FIG. 8 is a diagram showing an architecture of such a type of information system. In this information system, the schedule management program 3 of the personal computer 2 detects the unoccupied time for which the personal computer 2 is unused in the same procedures as those implemented by the information system in the first embodiment ((1) through (3) in FIG. 8).

Then, a program boot module contained in the schedule management program 3 boots a virus check program 4 ((4) in FIG. 8). Hereupon, the virus check program 4 executes the virus check about the hard disk within the personal computer 2 ((5) in FIG. 8). At this time, the program boot module of the schedule management program 3 waits till the virus check is finished.

The virus check program 4 notifies the schedule management program 3 of the end of the virus check, or the schedule management program 3 monitors the end of the virus check ((6) in FIG. 8), whereby the schedule management program 3 obtains a processing time till the end of the virus check since a boot time of the virus check program 4.

After finishing the virus check, the schedule management program 3, as a result of the process, records, for example, a hard disk used capacity of the personal computer 2 and the processing time on the processing result database 7 ((7) in FIG. 8). With this scheme, the present invention can be embodied in a local environment of the personal computer 2 without using the server 1.

Further, for instance, the virus check program itself is stored in the server 1, and the virus check about the hard disk of the personal computer 2 may also be carried out on the CPU of the server 1.

The execution of the virus check in this system architecture involves reading the data of the hard disk in the personal computer 2 from the program executed on the server 1. What is known as a function by which a plurality of computers share the hard disk may be, e.g., ActiveX (Microsoft's component technology over the Internet) and Sun Microsystems' NFS (Network File System) in the UNIX operating system.

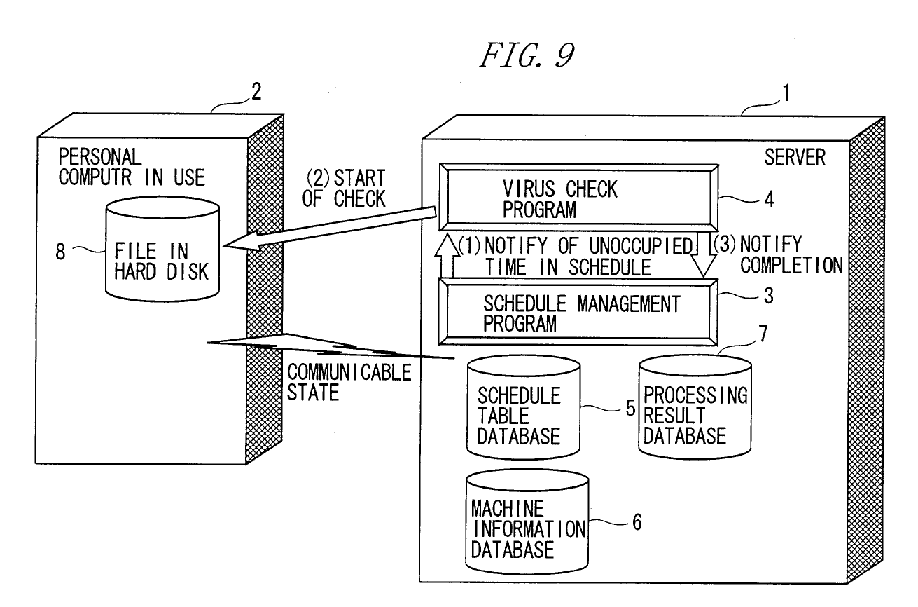

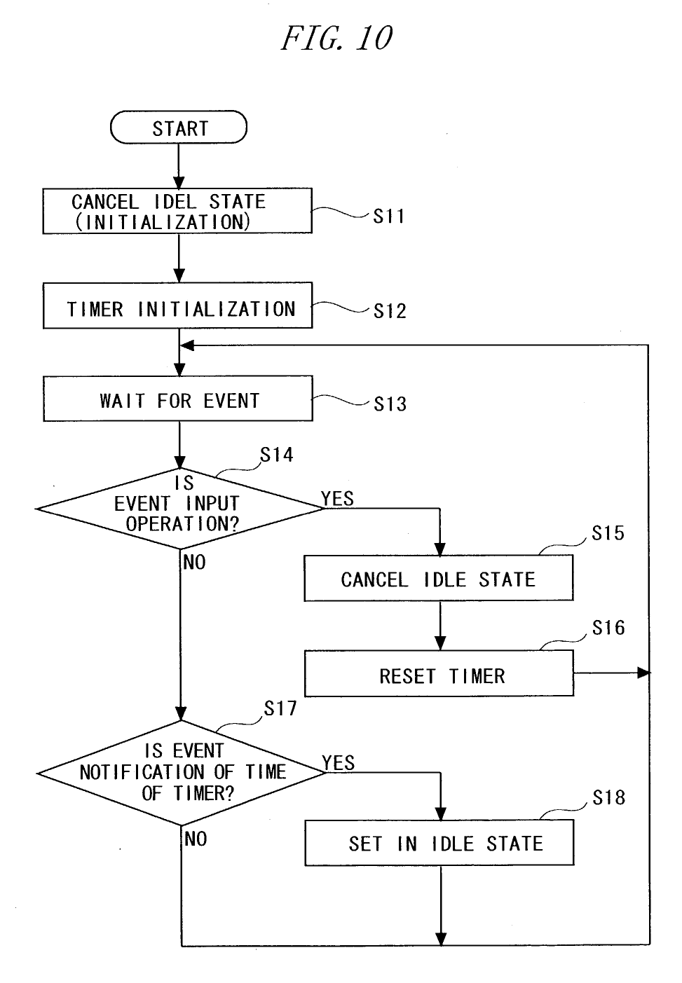

FIG. 9 is a diagram showing an architecture of such an information system. The information system in FIG. 9 is different from the information system in FIG. 1 in terms of such a point that the virus check program 4 runs on the sever 1.

Namely, the schedule management program 3 of the server 1 detects the unoccupied time for which the personal computer 2 is unused in the same procedures as those by the information system in the first embodiment, and notifies the virus check program 4 of this item of information (as indicated by (1) in FIG. 9). This item of information contains a machine ID for identifying the processing target personal computer 2, and so on.

Then, the virus check program executes the virus check about the hard disk in the personal computer 2 via the network ((2) in FIG. 9).

After finishing the virus check, the virus check program notifies the schedule management program 3 of the completion of the process ((3) in FIG. 9). The schedule management program 3, as a result of the process, records, for instance, a hard disk used capacity of the personal computer 2 and a processing time on the processing result database 7.

Further, for example, the personal computer 2 may execute the schedule management program 3, and the server 1 may carry out the virus check about the personal computer 2.

Namely, the personal computer 2 itself detects the unoccupied time and notifies the server 1 of this item of information. This item of information contains information for identifying the personal computer 2. Then, the server 1 may execute the virus check about the hard disk provided in the personal computer 2.

As discussed above, according to the embodiment of the present invention, it is not essential whether the environment is a stand-alone local platform or a networking platform on which the server 1 and the personal computer 2 operate in cooperation with each other.

Further, according to the embodiment of the present invention, it is not essential whether the program (which is, e.g., the virus check program) for executing the predetermined process is installed in the personal computer 2 or the server 1. Moreover, according to the embodiment of the present invention, it is not essential whether the schedule management program 3, the schedule table database 5 etc are retained on the personal computer 2 or the server 1.

<Modified Example of Process of Each Program>

According to the embodiment discussed above, the schedule management program 3 or the module contained in the schedule management program 3 detects the unoccupied time and boots the virus check program. That is, the process till the virus check program is booted is executed based on the schedule management program 3. The embodiment of the present invention is not, however, limited to the method and the process described above.

For example, a part of the process described above may be executed based on the virus check program. For instance, if the schedule table database 5 contains a schedule to be started at the present time, the information thereof may be transferred to the virus check program from the schedule management program 3.

Then, the virus check program 4 may judge whether there is the unoccupied time, estimate processing time and judge whether the process is completed within this unoccupied time.

Moreover, for instance, the process described in the first embodiment may be executed based on a process management program for making the schedule management program 3 and the virus check program 4 function in cooperation with each other.

Namely, the present invention may be embodied based on the process management that accesses the schedule table database 5, then detects the time unoccupied by the user and executes the predetermined process (virus check etc) within this unoccupied time.

The process management program is thus utilized, whereby the general-purpose schedule management program 3 and the general-purpose processing program (the virus check program, the backup program etc) can be used in combination. Further, this process management program may be incorporated into the OS.

For instance, a location of the schedule table database, a location of the processing program that should be executed in the unoccupied time, parameters transferred to this program and an initial value of the processing time, are set in a predetermined file. A service program attached to the OS reads this setting and may boot the processing program within the unoccupied time.

<Other Modified Examples>

According to the embodiment discussed above, it is judged whether the estimated value of the processing time falls within a schedule time with respect to each item of the individual schedule (the schedule management information) stored on the schedule table database 5. As a substitute for this process, however, in a plurality of consecutive schedules, if the user is absent, a time zone that joins the plurality of schedules together is obtained, and it may also be judged whether the estimated value of the processing time falls within the time zone of the joined schedules.

<<Second Embodiment>>

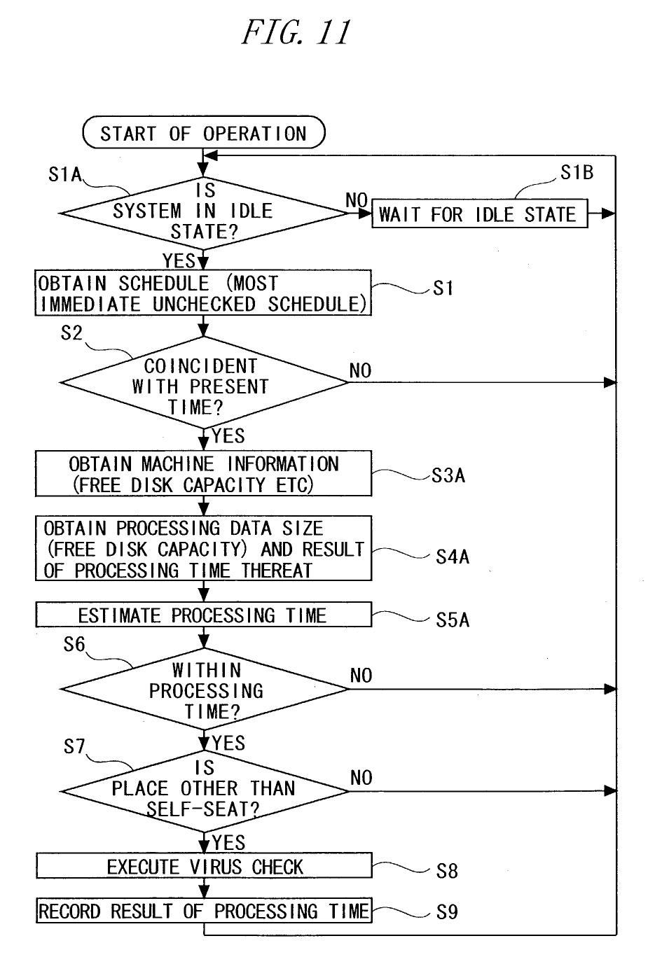

A second embodiment of the present invention will be described with reference to FIGS. 10 and 11. FIG. 10 is a flowchart showing a process of detecting an idle state of the personal computer 2 in the second embodiment. FIG. 11 is a flowchart showing a process of a program for starting up a predetermined process in the second embodiment.

The first embodiment has exemplified the information system that detects the unoccupied time for which the user does not use the personal computer 2, and executes the process such as the virus check etc within this unoccupied time.

The discussion in the second embodiment will be focused on an information system that judges whether the personal computer 2 is in the idle state wherein the computer 2 is actually unused. Other configurations and operations are the same as those in the first embodiment. Then, the same components are marked with the same numerals, and their repetitive explanations are omitted. Further, FIGS. 1 through 9 are referred to when the necessity arises.

<Outline of Process>

According to the second embodiment, this predetermined process (virus check etc) is executed in consideration of an actual using condition of the machine (personal computer 2 etc).

This using condition is judged from whether an input device such as a keyboard and a mouse is used. This process is utilized for judging a startup of a screen saver on Microsoft's Windows. This state where the machine is unused is called an idle state. Then, the present information system does not execute the predetermined process if not in the idle state even when the time is judged to be, for example, an unoccupied time from the information in the schedule table database 5.

<Operation>

FIG. 10 shows processing steps of an idle state detection program running on the personal computer 2. In this process, the program at first executes an initial setting for canceling the idle state (S11). This is a clear process of clearing a flag for managing the idle state.

Next, the program initializes a timer (S12). With this setting, a timer-based event occurs after a predetermined interval. According to this idle state detection program, if an input operation by the user is not detected till the timer-based event occurs, it is judged that the personal computer 2 is in the idle state.

Next, the program comes to a state of waiting for an event (S13). The program is notified of the event via a device driver and the OS by the input operation using the keyboard, the mouse etc. Further, the event includes a notification from the timer.

When the event occurs, the program judges a category of the event. To begin with, the program judges whether the event is the input operation (S14). If the event is the input operation, the program cancels the idle state (S15). This is, for example, the process of clearing the flag that indicates the idle state. Next, the program resets the timer (S16). Thereafter, the program returns the control to S13.

If the event is not the input operation, the program judges whether the event is a time elapse notification from the timer (S17). If the event is the time elapse notification from the timer, the program sets the idle state. The idle state is set as, for instance, a flag of a predetermined memory.

Thereafter, the program returns the control S13 without resetting the timer. In this case, the timer event does not occur from now onwards, it follows that idle state continues unless the input operation of the user is detected.

FIG. 11 shows the process of the program in the second embodiment. This process is substantially the same as the process in FIG. 7 except for steps S1A and S1B. In the second embodiment, however, an assumption is that all the processes are executed in a stand-alone mode by the personal computer 2.

Namely, according to the second embodiment, the personal computer 2 at first judges whether the device (the personal computer 2 itself) is in the idle state (S1A). Whether in the idle state or not can be known from how the flag on the unillustrated memory is set. Then, if not in the idle state, the personal computer 2 waits till the idle state occurs (S1B). Thereafter, the personal computer 2 returns the control S1A.

While on the other hand, when judging in S1A that the device is in the idle state, the personal computer 2 advances the control to S1. The processes subsequent thereto are the same as those in FIG. 7 in the first embodiment.

As discussed above, according to the second embodiment, it is judged whether the personal computer is unoccupied in a way that reflects whether the user performs the input operation in addition to the information in the schedule table database 5. As a result, if the user does not behave as the schedule registered on the schedule management program 3 indicates, for example, in the case of failing to change the schedule data in spite of having changed the schedule, or in the case of erroneously registering the schedule data, there decreases a possibility in which a hindrance against the operation of the user occurs.

Namely, it is feasible to judge more accurately by taking this idle state into account that the user does not use the personal computer.

<Modified Examples>

The second embodiment has exemplified the information system that detects the idle state and the unoccupied time and executes the predetermined process in the personal computer 2. These processes may also, however, be executed in combination with the server 1 as in the first embodiment. In this case, for instance, the server 1 may query the personal computer 2 about whether the personal computer 2 is in the idle state. Further, the server 1 may also be notified of the personal computer 2 being in the idle state.

Note that a processing content in S4 shown in FIG. 5 may be executed in place of the processing contents in S3A through S5A shown in FIG. 11. Namely, as discussed in the first embodiment, the result value of the processing time may simply be used as an estimated value of the processing time without taking into account the hard disk used capacity and so on.

According to the second embodiment, as in S1A in FIG. 11, it is at first judged whether in the idle state or not. As a substitute for this process, however, whether in the idle state or not may also be judged after S2 (judging that the present time is coincident with the predetermined time) in FIG. 1, or after S6 (judging whether the processing time falls within the predetermined time), or after S7 (judging whether the predetermined place is other than the user's seat).

<<Third Embodiment>>

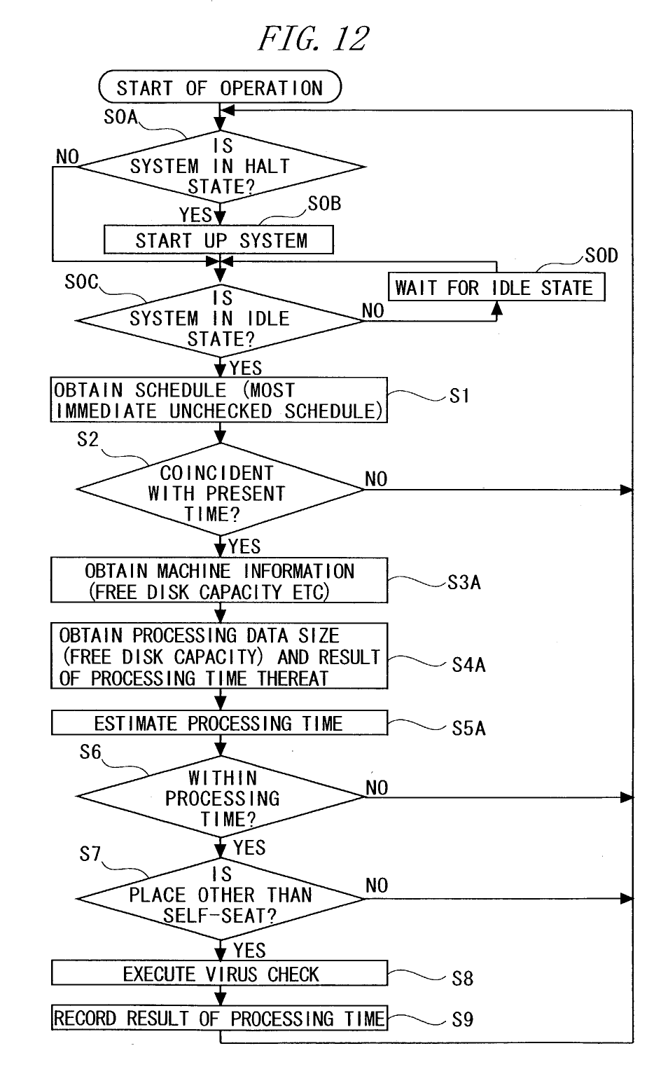

A third embodiment of the present invention will be described with reference to FIG. 12. FIG. 12 is a flowchart showing a process of the program that starts up the predetermined process in the third embodiment.

The second embodiment has exemplified the information system executing the predetermined process, e.g., the virus check in a way that reflects the idle state. The third embodiment will further exemplify an information system that judges whether the device executing the predetermined process is in a halt state, then starts up, if in the halt state, this device, and executes the predetermined process. Other configurations and operations are same as those in the first and second embodiments. Then, the same components are marked with the same numerals, and their repetitive explanations are omitted. Further, FIGS. 1 through 11 are referred to when the necessity arises.

FIG. 12 shows the process of the program starting up the predetermined process in the server according to the third embodiment. This process is substantially the same as the process in FIG. 11, excluding steps S0A through S0D. According to the third embodiment, however, the process in FIG. 12 is executed on the network platform including the server 1.

Namely, in the third embodiment, the server 1, to start with, judges whether the device (the personal computer 2) is in the halt state (S0A). Whether in the halt state or not can be judged by sending a query to the target device via the network and knowing whether a response thereto is sent back or not. What is known as the query function described herein is Ping (Packet Internet Groper) command that makes it possible to confirm whether an IP packet reaches a destination of the communication in, e.g., TCP/IP network.

If the device is in the halt state, the server 1 starts up the device (S0B). What is known as a function of starting up the device remaining halted is WakeOn LAN, WakeOn RING etc. This is a function of starting up the computer mounted with a LAN (local Area Network) board from its halted state by sending a predetermined packet to the LAN board in LAN.

Next, the server 1 queries the device about whether the device is in the idle state (S0C). Then, if not in the idle state, the server 1 waits till the device comes to the idle state (S0D). When becoming the idle state, the server 1 returns the control to S0C.

While on the other hand, in the case of judging in S0C that the device is in the idle state, the server 1 advances the control to S1. The processes subsequent thereto are the same as in the case of FIGS. 5 and 7 or FIG. 11.

As discussed above, the information system according to the third embodiment, even when the device such as the personal computer 2 etc executing the predetermined process is in the halt state, can start up the device and make the device execute the predetermined process. Accordingly, the predetermined process exhibiting a large load and not directly related to the operations by the user, can be executed when the user is absent due to a business trip or during a nighttime off the duty. According to the present information system, the predetermined process can be executed during a long-term absence of the user, whereby an effective utilization factor of the personal computer 2 can be improved.

Note that the processing content in S4 shown in FIG. 5 may be executed as a substitute for the processing contents in S3A through S5A shown in FIG. 12 in the third embodiment. That is, as described in the first embodiment, the result value of the processing time may be simply used as the estimated value of the processing time without taking the hard disk used capacity etc into account.

<<Other Modified Examples>>

According to the first through third embodiments, whether there is the unoccupied time is judged based on knowing whether the place for carrying out the schedule is the user's seat. For example, however, if it is known whether the schedule is carried out somewhere other than at the user's seat, the judgement as to whether the place excludes the user's seat is unnecessary, and the system may simply judge an unoccupied time for which the user does not use the personal computer 2 from the time schedule set in the schedule management information.

According to the first through third embodiments, a candidate for the startup time zone of the virus check etc is obtained only from the present time and the schedule recorded on the schedule table database 5 (refer to, e.g., the description in FIG. 2 in the first embodiment and S1 and S2 in FIG. 5).

Instead of this, however, another possible scheme is that a schedule just immediate to a date/time after an elapse of a specified time since the time when (the process such as) the virus check has been executed last time, or a date/time after an elapse of a predetermined time set by the user since then, is set as a candidate for the time zone for starting up the virus check. Namely, the schedule set after the elapse of the predetermined time since the vircus check was executed last time, may also be judged to be a candidate for the time zone for starting up the virus check.

According to the first through third embodiments, when selecting from the schedules a candidate for the processing time zone for starting up the predetermined process such as the virus check etc, the schedule with the [user's seat] set as a schedule implementation place is ruled out (refer to S6 etc in FIG. 5). The embodiment of the present invention is not, however, limited to this procedure. Namely, a schedule with a setting of different place from the [user's seat] may be, as a matter of course, ruled out of the processing time zone candidate.

According to the first through third embodiments, the schedule implementation place is determined after judging whether the processing time falls within the schedule time (refer to, for instance, S5 and S6 in FIG. 5). As a substitute for this, another possible scheme is that whether the processing time falls within the schedule time may be judged after determining the schedule implementation place.

<<A storage medium readable by a machine>>

A program executed by a computer or other device or machine etc to actualize any one of the functions described above may be recorded on a storage medium readable by a machine. Then, the computer or other device or machine etc reads and executes the program on this recording medium, whereby this function can be provided.

Herein, the storage medium readable by a machine embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<<Data Communication Signal Embodied in Carrier Wave>>

Furthermore, the above program may be stored in the hard disk and the memory of the computer, and downloaded to other computer or other device or machine etc via communication media. In this case, the program is transmitted as data communication signals embodied in carrier waves via the communication media. Then, the computer or other device or machine etc downloaded with this program can be made to provide the above function.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. A processing system comprising:
a module referring to schedule information of a user using said processing system;
a module judging, based on the schedule information, an unoccupied time of said processing system for which the user does not use said processing system; and
an execution module executing a predetermined process in the unoccupied time.

2. A processing system according to claim 1, further comprising:
a module referring to a processing time needed to complete the predetermined process when the predetermined process was executed in the past; and
a module comparing the processing time with the unoccupied time,
wherein said execution module executes the predetermined process if the processing time does not exceed the unoccupied time.

3. A processing system according to claim 1, further, the predetermined process being a data process, comprising:
a module recording information on a used storage capacity of data processed by this data process and a processing time of the data process of the same data;
a module estimating the processing time from a relationship between the information on the used storage capacity when the data process was executed in the past and information on a present used storage capacity; and
a module comparing the estimated processing time with the unoccupied time,
wherein said execution module executes the predetermined process if the estimated processing time does not exceed the unoccupied time.

4. A processing system according to claim 3, further comprising a module referring to an unused storage capacity of a medium storing the data,
wherein said estimating module estimates the processing time in a way that uses the unused storage capacity as the information on the used storage capacity.

5. A processing system according to claim 1, wherein said module referring to the schedule information refers to schedule information retained on a predetermined server.

6. A processing system according to claim 1, further comprising:
a module detecting a user operation; and
a module controlling the execution of the predetermined process on the basis of a result of detecting the user operation.

7. A processing system according to claim 1, wherein the predetermined process includes any one of processes or one or more processes such as a computer virus check process, an integrating process of free areas on said medium storing the data, a delete process clearing a real content of already-deleted data and a copying process of the predetermined data.

8. A server comprising:
a module referring to schedule information of a user using a processing system;
a module judging, based on the schedule information, an unoccupied time of said processing system for which the user does not use said processing system; and
a module commanding said processing system to execute a predetermined process in the unoccupied time.

9. A server accessing resources possessed by a predetermined processing system, comprising:
a module referring to schedule information of a user using said processing system;
a module judging, based on the schedule information, an unoccupied time of said processing system for which the user does not use said processing system; and
a module executing a predetermined process about the resources of said processing system in the unoccupied time.

10. A server according to claim 8, further comprising:
a module judging whether said processing system is in a halt state; and
a module starting up said processing system when said processing system is in the halt state.

11. A server according to claim 8, further comprising:
a module referring to a processing time needed to complete the predetermined process when the predetermined process was executed in the past; and
a module comparing the processing time with the unoccupied time.

12. A server according to claim 8, further, the predetermined process being a data process, comprising:
a module recording information on a used storage capacity of data processed by this data process and a processing time of the data process of the same data;
an estimating module estimating the processing time from a relationship between the information on the used storage capacity when the data process was executed in the past and information on a present used storage capacity; and
a module comparing the estimated processing time with the unoccupied time.

13. A server according to claim 12, further comprising a module referring to an unused storage capacity of a medium storing the data,
wherein said estimating module estimates the processing time in a way that uses the unused storage capacity as the information on the used storage capacity.

14. A server according to claim 8, further comprising:
a module detecting a user operation about said processing system; and
a module controlling the execution of the predetermined process on the basis of a result of detecting the user operation.

15. An executing method of a predetermined process, comprising:
referring to schedule information of a user using a processing system;
judging, based on the schedule information, an unoccupied time of said processing system for which the user does not use said processing system; and
executing the predetermined process in the unoccupied time.

16. An executing method according to claim 15, further comprising:
referring to a processing time needed to complete the predetermined process when the predetermined process was executed in the past;
comparing the processing time referred to with the unoccupied time; and
starting up the execution of the predetermined process if the processing time does not exceed the unoccupied time.

17. An executing method according to claim 15, further, the predetermined process being a data process, comprising:
recording information on a used storage capacity of data processed by this data process and a processing time of the data process of the same data;
estimating the processing time from a relationship between the information on the used storage capacity when the data process was executed in the past and information on a present used storage capacity;
comparing the estimated processing time with the unoccupied time; and
starting up the execution of the predetermined process if the estimated processing time does not exceed the unoccupied time.

18. An executing method according to claim 17, further comprising referring to an unused storage capacity of a medium storing the data,
wherein, in the estimating the processing time, the unused storage capacity is used as the information on the used storage capacity

19. An executing method according to claim 15, wherein, in the referring to schedule, information retained on a predetermined server is referred.

20. An executing method according to claim 15, further comprising:
detecting a user operation; and
controlling the execution of the predetermined process on the basis of a result of detecting the user operation.

21. An executing method according to claim 15, wherein the predetermined process includes any one of processes or one or more processes such as a computer virus check process, an integrating process of free areas on said medium storing the data, a delete process clearing a real content of already-deleted data and a copying process of the predetermined data.

22. An executing method of a predetermined process executed by a computer communicable with a processing system, comprising:
referring to schedule information of a user using said processing system;
judging, based on the schedule information, an unoccupied time of said processing system for which the user does not use said processing system; and
commanding said processing system to execute the predetermined process in the unoccupied time.

23. An executing method of a predetermined process by which a computer accesses resources of a predetermined processing system and executes a predetermined process, said method comprising:
referring to schedule information of a user using said processing system;
judging, based on the schedule information, an unoccupied time of said processing system for which the user does not use said processing system; and
executing such a predetermined process as to utilize the resources of said processing system in the unoccupied time.

24. An executing method according to claim 22, further comprising:
judging whether said processing system is in a halt state; and
starting up said processing system when said processing system is in the halt state.

25. An executing method according to claim 22, further comprising:
referring to a processing time needed to complete the predetermined process when the predetermined process was executed in the past; and
comparing the processing time referred to with the unoccupied time.

26. An executing method according to claim 22, further, the predetermined process being a data process, comprising:
recording information on a used storage capacity of data processed by this data process and a processing time of the data process of the same data;
estimating the processing time from a relationship between the information on the used storage capacity when the data process was executed in the past and information on a present used storage capacity; and
comparing the estimated processing time with the unoccupied time.

27. An executing method according to claim 26, further comprising referring to an unused storage capacity of a medium storing the data,
wherein, in the estimating the processing time, the unused storage capacity is used as the information on the used storage capacity.

28. An executing method according to claim 22, further comprising:
detecting a user operation about said processing system; and
controlling the execution of the predetermined process on the basis of a result of detecting the user operation.

29. A storage medium readable by a machine, tangible embodying a program of instructions executable by the machine to perform method steps comprising:
referring to schedule information of a user using a processing system;
judging, based on the schedule information, an unoccupied time of said processing system for which the user does not use said processing system; and
executing the predetermined process in the unoccupied time.

30. A storage medium readable by a machine tangible embodying a program according to claim 29, further comprising:
referring to a processing time needed to complete the predetermined process when the predetermined process was executed in the past;
comparing the processing time referred to with the unoccupied time; and
starting up the execution of the predetermined process if the processing time does not exceed the unoccupied time.

31. A storage medium readable by a machine tangible embodying a program according to claim 29, further, the predetermined process being a data process, comprising:
recording information on a used storage capacity of data processed by this data process and a processing time of the data process of the same data;
estimating the processing time from a relationship between the information on the used storage capacity when the data process was executed in the past and information on a present used storage capacity;
comparing the estimated processing time with the unoccupied time; and
starting up the execution of the predetermined process if the estimated processing time does not exceed the unoccupied time.

32. A storage medium readable by a machine tangible embodying a program according to claim 31, further comprising referring to an unused storage capacity of a medium storing the data,
wherein, in the estimating the processing time, the unused storage capacity is used as the information on the used storage capacity.

33. A storage medium readable by a machine tangible embodying a program according to claim 29, wherein, in the referring to the schedule information, the schedule information retained on a predetermined server is referred.

34. A storage medium readable by a machine tangible embodying a program according to claim 29, further comprising:
detecting a user operation; and
controlling the execution of the predetermined process on the basis of a result of detecting the user operation.

35. A storage medium readable by a machine tangible embodying a program according to claim 29, wherein the predetermined process includes any one of processes or one or more processes such as a computer virus check process, an integrating process of free areas on said medium storing the data, a delete process clearing a real content of already-deleted data and a copying process of the predetermined data.

36. A storage medium readable by a machine, tangible embodying a program of instructions executable by the machine communicable with a processing system to execute a predetermined process, comprising:
referring to schedule information of a user using said processing system;
judging, based on the schedule information, an unoccupied time of said processing system for which the user does not use said processing system; and
commanding said processing system to execute the predetermined process in the unoccupied time.

37. A storage medium readable by a machine, tangible embodying a program by which the machine accesses resources of a predetermined processing system and executes a predetermined process, said program comprising:
referring to schedule information of a user using said processing system;
judging, based on the schedule information, an unoccupied time of said processing system for which the user does not use said processing system; and
executing such a predetermined process as to utilize the resources of said processing system in the unoccupied time.

38. A storage medium readable by a machine, tangible embodying a program according to claim 36, further comprising:
judging whether said processing system is in a halt state; and
starting up said processing system when said processing system is in the halt state.

39. A storage medium readable by a machine, tangible embodying a program according to claim 36, further comprising:
referring to a processing time needed to complete the predetermined process when the predetermined process was executed in the past; and
comparing the processing time referred to with the unoccupied time.

40. A storage medium readable by a machine, tangible embodying a program according to claim 36, further, the predetermined process being a data process, comprising:
recording information on a used storage capacity of data processed by this data process and a processing time of the data process of the same data;
estimating the processing time from a relationship between the information on the used storage capacity when the data process was executed in the past and information on a present used storage capacity; and
comparing the estimated processing time with the unoccupied time.

41. A storage medium readable by a machine, tangible embodying a program according to claim 40, further comprising referring to an unused storage capacity of a medium storing the data,
wherein in the estimating the processing time, the unused storage capacity is used as the information on the used storage capacity.

42. A storage medium readable by a machine, tangible embodying a program according to claim 36, further comprising:
detecting a user operation about said processing system; and
controlling the execution of the predetermined process on the basis of a result of detecting the user operation.
